(19) United States
(12) Patent Application Publication
(10) Pub. No.: US 2025/0340433 A1
(43) Pub. Date: Nov. 6, 2025

(54) RUTHENIUM-DOPED ALUMINA-SUPPORTED COBALT/NICKEL CATALYST FOR AMMONIA DECOMPOSITION TO HYDROGEN AND NITROGEN

(71) Applicant: KING FAHD UNIVERSITY OF PETROLEUM AND MINERALS, Dhahran (SA)

(72) Inventors: M. Nasiruzzaman SHAIKH, Dhahran (SA); Afnan M. AJEEBI, Dhahran (SA); Omar Mohammad O. ALAMOUDI, Dhahran (SA); Mohammed Ahmed SANHOOB, Dhahran (SA); Mohammad M. HOSSAIN, Dhahran (SA)

(73) Assignee: KING FAHD UNIVERSITY OF PETROLEUM AND MINERALS, Dhahran (SA)

(21) Appl. No.: 18/652,361

(22) Filed: May 1, 2024

(51) Int. Cl. C01B 3/04; B01J 8/02; B01J 23/89; B01J 35/45; B01J 35/51; B01J 37/04; B01J 37/08

(52) U.S. Cl. CPC C01B 3/047; B01J 8/025; B01J 23/892; B01J 35/45; B01J 35/51; B01J 37/04; B01J 37/082; B01J 2235/15; B01J 2235/30; C01B 2203/0277; C01B 2203/1017; C01B 2203/1058; C01B 2203/1064

(57) ABSTRACT

A method for ammonia (NH₃) decomposition to hydrogen (H₂) and nitrogen (N₂) using a ruthenium-doped alumina-supported cobalt/nickel (Ru—CoNi/Al₂O₃) catalyst. The method includes introducing and passing an NH₃-containing feed gas stream into a reactor to contact the NH₃-containing feed gas stream with a reduced Ru—CoNi/Al₂O₃ catalyst at a temperature of 100 to 1000° C. thereby converting at least a portion of the NH₃ to H₂ and regenerating the Ru—CoNi/Al₂O₃ catalyst particles to form a regenerated Ru—CoNi/Al₂O₃ catalyst, and producing a residue gas stream leaving the reactor.

### STATEMENT OF ACKNOWLEDGEMENT

This research was supported by the Interdisciplinary Research Center for Hydrogen and Energy Storage (IRC-HES) at King Fahd University of Petroleum and Minerals (KFUPM), Dhahran, Saudi Arabia, under the Project H2HC2312.

### BACKGROUND

### Technical Field

The present disclosure is directed to a method for decomposing ammonia (NH₃), and more particularly, to a method for decomposing NH₃ to hydrogen (H₂) and nitrogen (N₂) using a ruthenium-doped alumina-supported cobalt/nickel (Ru—CoNi/Al₂O₃) catalyst.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Hydrogen, recognized as a key clean energy carrier, is taking one of the leading positions in the energy sector. Despite many advantages, the direct handling of hydrogen in pure form is undesirable due to the high reactivity with metals, which can lead to embrittlement of storage containers. Additionally, storing hydrogen in a container as a compressed gas requires extremely high pressure, reaching up to 700 bar at 25 degrees Celsius (° C.). Therefore, the physical storage of hydrogen by adsorption in porous materials, such as MOFs, zeolites, porous carbon, and polymers, emerges as a viable alternative. However, this adsorption process often requires operation at very low temperatures (e.g., for MOF-177; −196° C. for 7.5 wt. % of hydrogen adsorption) and suffers from limited reversibility. Furthermore, hydrogen storage can also be achieved chemically through its incorporation into various chemical compounds. For instance, methanol (CH₃OH), methane (CH₄), metal amine salts (e.g., Mg(NH₃)₆Cl₂), ammonia borane (e.g., iminoborane, polyiminoborane, polyborazylene, cyclotriborazane (NH₂BH₂)₃ etc.), liquid organic hydrogen carrier (LOHC) (e.g., perhydro N-ethylcarbazole contain 5.8 wt. % hydrogen) and metal hydrides (interstitial H as in LaNi₅H₆ or complex hydrides such as NaAlH₄) are emerging as important storage materials.

Unlike the conventionally available hydrogen storage materials, ammonia has emerged as an attractive liquid fuel for hydrogen owing to its facile transportation in the form of a chemical compound. Additionally, other attributes of ammonia include high capacity of hydrogen storage (17.6 wt. %) based on its molecular structure, cost efficiency, established technology for the production of ammonia and above all, devoid of carbon footprint. Moreover, ammonia possesses characteristics such as easy liquefaction under mild conditions and low vapor pressure (8.9 bar), making it easy to store in inexpensive pressure vessels. However, in order to direct and point-of-use release hydrogen from ammonia, significant energy input as well as reactor mass and volume, are required. In addition, toxicity, corrosive nature, and incompatibility of polymer electrolyte membrane (PEM) fuel cells for ammonia restrict their commercial endeavors.

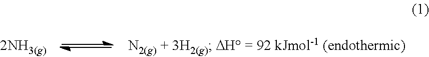

Therefore, the production of pure hydrogen from cracked ammonia represents a technology in terms of efficiency and enhanced environmental credentials. In this process, H₂ can be generated from NH₃ by passing over a solid-supported catalyst bed under a heating condition, thereby decomposing ammonia into hydrogen and nitrogen (Eq. 1). While this method is utilized by various industries, such as Lindberg/MPH, CI Hayes, Koyo Thermo and Sergeant &Wilbur Inc it is typically implemented on a small scale (1-2 ton per day). However, its reaction kinetics is retarded by its higher activation energy for the N—H bond cleavage and low N₂ desorption rates. Ru on different metal oxides or structured and unstructured carbon often show catalytic activity in ammonia decomposition due to its metal-nitrogen desorption energy, such as Ru/CNT (ruthenium supported on carbon nanotube) catalysts (See: A. K. Hill, L. Torrente-Murciano, Int. J. Hydrogen Energy 2014, 39, 7646-7654). However, ruthenium is a noble metal and consequently expensive. Additionally, higher operational temperatures (>600° C.) and the problem with relatively faster deactivation of the catalysts pose challenges. Therefore, a low-cost catalyst with comparable reactivity to ruthenium is desirable. Therefore, proper active metal combination with controlled morphology, electronic structure, defect, and doping are explored. Moreover, support has a considerable impact on ammonia decomposition activity. For example, metal catalysts on the carbon nanotube supports for the ammonia decomposition reaction at 400° C. show the activity order of Ru>Rh≈Ni>Pt≈Pd>Fe. (See: S.-F. Yin, Q.-H. Zhang, B.-Q. Xu, W.-X. Zhu, C.-F. Ng, C.-T. Au, J. Catal. 2004, 224, 384-396). But when the same active metal is placed on the alumina support, a different activity trend is noted, (See: J. C. Ganley, F. S. Thomas, E. G. Seebauer, R. I. Masel, Catal. Letters 2004, 96, 117-122). Thus, support may stabilize the active metal particles, increase the exposure of their active sites, and affect the electronic structure of the supported metal.

Non-precious transition metals, such as Co, Ni, Cu, Mo, and different combinations of metals, such as Co—Mo, Ni—Mo, Fe—Mo, Ni—Co, Co—Mo—Fe—Ni—CU, Mg—Fe, Fe—Co, Mg—Co—Fe, Ni—Pt, Cu—Zn and Ir—Ni, and bimetallic compositions of Ru on solid supports have been explored. For instance, the fabrication of Co nanoparticles on titania and its application in ammonia decomposition reaction was studied (See: H. A. Lara-Garcia, J. A. Mendoza-Nieto, H. Pfeiffer, L. Torrente-Murciano, Int. J. Hydrogen Energy 2019, 44, 30062-30074). A series of K-promoted Ru—Ni on Al₂O₃ catalysts for hydrogen generation at lower temperatures were also examined (See: K. McCullough, P.-H. Chiang, J. D. Jimenez, J. A. Lauterbach, Materials (Basel). 2020, 13, 1869).

Although several earth-abundant transition metal-based catalysts have been developed in the past for catalytic ammonia decomposition, more efficient catalysts with enhanced ammonia decomposition activity still need to be fabricated and explored.

In view of the foregoing, it is one objective of the present disclosure to provide a method for ammonia (NH₃) decomposition to hydrogen (H₂) and nitrogen (N₂). This catalytic ammonia decomposition process employs a ruthenium-doped alumina-supported cobalt/nickel (Ru—CoNi/Al₂O₃) catalyst. A second objective of the present disclosure is to provide a method of making the Ru—CoNi/Al₂O₃ catalyst.

### SUMMARY

In an exemplary embodiment, a method for ammonia (NH₃) decomposition to hydrogen (H₂) and nitrogen (N₂) is provided. In some embodiments, the method includes introducing a H₂-containing feed gas stream into a reactor containing a ruthenium-doped alumina-supported cobalt/nickel (Ru—CoNi/Al₂O₃) catalyst including Ru—CoNi/Al₂O₃ catalyst particles. In some embodiments, Ru is present in the Ru—CoNi/Al₂O₃ catalyst at a concentration of 0.01 to 5 wt. % based on a total weight of the Ru—CoNi/Al₂O₃ catalyst. In some embodiments, the method further includes passing the H₂-containing feed gas stream through the reactor to contact the H₂-containing feed gas stream with the Ru—CoNi/Al₂O₃ catalyst particles at a temperature of 500 to 900 degrees Celsius (° C.) to form a reduced Ru—CoNi/Al₂O₃ catalyst. Furthermore, the method includes terminating the introduction of the H₂-containing feed gas stream and introducing and passing an NH₃-containing feed gas stream through the reactor to contact the NH₃-containing feed gas stream with the reduced Ru—CoNi/Al₂O₃ catalyst at a temperature of 100 to 1000° C. thereby converting at least a portion of the NH₃ to H₂ and regenerating the Ru—CoNi/Al₂O₃ catalyst particles to form a regenerated Ru—CoNi/Al₂O₃ catalyst, and producing a residue gas stream leaving the reactor. In some embodiments, the method further includes separating the H₂ from the residue gas stream to generate a H₂-containing product gas stream.

In some embodiments, the Ru—CoNi/Al₂O₃ catalyst includes irregular shaped particles and spherical-shaped particles.

In some embodiments, the spherical-shaped particles have an average particle size in a range of 100 to 200 nanometers (nm).

In some embodiments, Al₂O₃ is present in the Ru—CoNi/Al₂O₃ catalyst at a concentration of 30 to 70 wt. % based on the total weight of the Ru—CoNi/Al₂O₃ catalyst.

In some embodiments, a molar ratio of Co to Ni present in the Ru—CoNi/Al₂O₃ catalyst is in a range of 20:1 to 1:20.

In some embodiments, the H₂ is present in the H₂-containing feed gas stream at a concentration of 90 to 99.99 vol. % based on a total volume of the H₂-containing feed gas stream.

In some embodiments, the NH₃ is present in the NH₃-containing feed gas stream at a concentration of 5 to 20 vol. % based on a total volume of the NH₃-containing feed gas stream.

In some embodiments, the NH₃-containing feed gas stream further includes an inert gas selected from the group consisting of nitrogen, argon, and helium. In some embodiments, a volume ratio of the NH₃ to the inert gas present in the NH₃-containing feed gas stream is in a range of 1:4 to 1:20.

In some embodiments, the NH₃-containing feed gas stream further includes helium. In some embodiments, the residue gas stream leaving the reactor includes ammonia, nitrogen, helium, and hydrogen.

In some embodiments, the reactor is at least one selected from the group consisting of a fixed-bed reactor, a trickle-bed reactor, a moving bed reactor, a rotating bed reactor, a fluidized bed reactor, and a slurry reactor.

In another exemplary embodiment, the reactor is disclosed. In some embodiments, the reactor is a fixed-bed reactor in the form of a cylindrical reactor including a top portion, a cylindrical body portion, a bottom portion, and a housing having an open top and open bottom supportably maintained with the cylindrical body portion. In some embodiments, the Ru—CoNi/Al₂O₃ catalyst is supportably retained within the housing permitting fluid flow therethrough and at least one propeller agitator disposed in the bottom portion of the reactor. In some embodiments, the bottom portion is cone-shaped or pyramidal and a plurality of recirculation tubes fluidly connects the bottom portion of the cylindrical reactor with the cylindrical body portion of the cylindrical reactor.

In some embodiments, the reactor has an aspect ratio of length (L) to inner diameter (ID) of 10:1 to 50:1.

In some embodiments, the passing the H₂-containing feed gas stream through the reactor at a weight hourly space velocity of about 18,000 L/Kg_{cat}/hr at a temperature of about 700° C.

In some embodiments, the passing the NH₃-containing feed gas stream through the reactor at a weight hourly space velocity of about 20,400 L/Kg_{cat}/hr at a temperature of from 400 to 700° C.

In some embodiments, the method has an ammonia conversion of 60 to 99% based on an initial concentration of the NH₃ in the feed gas stream.

In another exemplary embodiment, a method of preparation of the Ru—CoNi/Al₂O₃ catalyst is disclosed. In some embodiments, the method includes grinding and mixing a cobalt salt, a nickel salt, and an alumina support to form a first mixture and calcining the first mixture at a temperature of about 500° C. to form a CoNi/Al₂O₃ composite. In some embodiments, the method further includes grinding and mixing a ruthenium salt and the CoNi/Al₂O₃ composite to form a second mixture and calcining the second mixture at a temperature of about 500° C.

In some embodiments, a weight ratio of the cobalt salt to the nickel salt present in the first mixture is in a range of 20:1 to 1:20.

In some embodiments, the alumina support is at least one selected from the group consisting of a gamma-alumina support (γ-Al₂O₃), an alpha-alumina support (α-Al₂O₃), and a delta-alumina support (δ-Al₂O₃).

In some embodiments, the cobalt salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate.

In some embodiments, the nickel salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

In some embodiments, the ruthenium salt includes ruthenium sulfate, ruthenium acetate, ruthenium citrate, ruthenium iodide, ruthenium chloride, ruthenium perchlorate, ruthenium nitrate, ruthenium phosphate, ruthenium triflate, ruthenium bis(trifluoromethanesulfonyl)imide, ruthenium tetrafluoroborate, ruthenium bromide, and/or its hydrate.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a method flowchart for ammonia (NH₃) decomposition to hydrogen (H₂) and nitrogen (N₂), according to certain embodiments;

FIG. 1B is a method flowchart for preparing ruthenium-doped alumina-supported cobalt/nickel (Ru—CoNi/Al₂O₃) catalyst, according to certain embodiments;

FIG. 1C is a pictorial representation of ammonia cracking, according to certain embodiments;

FIG. 2A shows X-ray diffraction (XRD) patterns of Ni/Al₂O₃, Co/Al₂O₃, CoNi/Al₂O₃ catalysts, according to certain embodiments;

FIG. 2B shows XRD patterns of 0.5% ruthenium (Ru) doped catalysts, namely Ru—Ni/Al₂O₃, Ru—Co/Al₂O₃, Ru—CoNi/Al₂O₃ catalysts, according to certain embodiments;

FIG. 3A is a scanning electron microscopic (SEM) image of the Ni/Al₂O₃ catalyst, according to certain embodiments;

FIG. 3B is a SEM image of the Co/Al₂O₃ catalyst, according to certain embodiments;

FIG. 3C is a SEM image of the CoNi/Al₂O₃ catalyst, according to certain embodiments;

FIG. 3D is a SEM image of the 0.5% Ru-doped Ni/Al₂O₃ catalyst, according to certain embodiments;

FIG. 3E is a SEM image of the 0.5% Ru-doped Co/Al₂O₃ catalyst, according to certain embodiments;

FIG. 3F is a SEM image of the 0.5% Ru-doped CoNi/Al₂O₃ catalyst, according to certain embodiments;

FIG. 4A is an energy dispersive X-ray spectroscopic (EDS)-elemental mapping image of the Ni/Al₂O₃ catalyst, according to certain embodiments;

FIG. 4B is an EDS-elemental mapping image of the Co/Al₂O₃ catalyst, according to certain embodiments;

FIG. 4C is an EDS-elemental mapping image of the CoNi/Al₂O₃ catalyst, according to certain embodiments;

FIG. 4D is an EDS-elemental mapping image of the 0.5% Ru-doped Ni/Al₂O₃ catalyst, according to certain embodiments;

FIG. 4E is an EDS-elemental mapping image of the 0.5% Ru-doped Co/Al₂O₃ catalyst, according to certain embodiments;

FIG. 4F is an EDS-elemental mapping image of the 0.5% Ru-doped CoNi/Al₂O₃ catalyst, according to certain embodiments;

FIG. 5A is an EDS spectrum of the 0.5% Ru-doped Ni/Al₂O₃ catalyst, according to certain embodiments;

FIG. 5B is an EDS spectrum of the 0.5% Ru-doped Co/Al₂O₃ catalyst, according to certain embodiments;

FIG. 5C is an EDS spectrum of the 0.5% Ru-doped CoNi/Al₂O₃ catalyst, according to certain embodiments; and

FIG. 6 is a graph depicting NH₃ decomposition with 10% NH₃ flow balanced with 90% helium (He) gas using 100 milligrams (mg) of catalyst under 24000 gas hourly speed velocity (GHSV), according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term “porosity” refers to a measure of the void or vacant spaces within a material.

As used herein, the terms “particle size” and “pore size” may be thought of as the lengths or longest dimensions of a particle and of a pore opening, respectively.

As used herein, the term “sonication” refers to the process in which sound waves are used to agitate particles in a solution.

As used herein the term “deionized water” refers to the water that has (most of) the ions removed.

As used herein, the term “calcination” refers to heating a compound to a high temperature, under a restricted supply of ambient oxygen. This is performed to remove impurities or volatile substances and to incur thermal decomposition.

As used herein, the term “thermal decomposition (or thermolysis)” refers to a chemical decomposition initiated by heat. The decomposition temperature is the temperature at which a substance undergoes chemical decomposition.

As used herein, the term “aspect ratio” refers to the ratio of length to width of cylinder.

As used herein, the term “weight hourly space velocity (WHSV)” refers to the weight of feed flowing per unit weight of the catalyst per hour.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

The present disclosure is intended to include all isotopes of a given compound or formula, unless otherwise noted.

Aspects of the present disclosure are directed toward use of a ruthenium-doped alumina-supported cobalt/nickel (Ru—CoNi/Al₂O₃) catalyst for low-temperature ammonia decomposition to produce high-purity hydrogen.

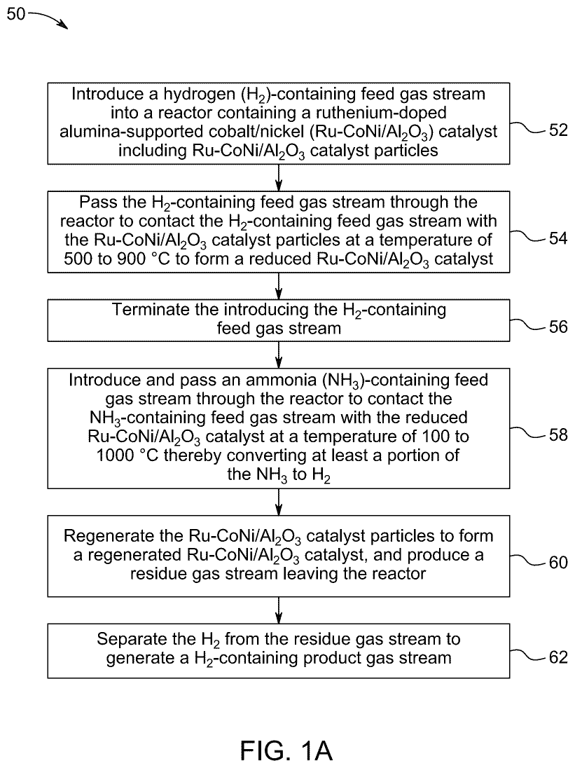

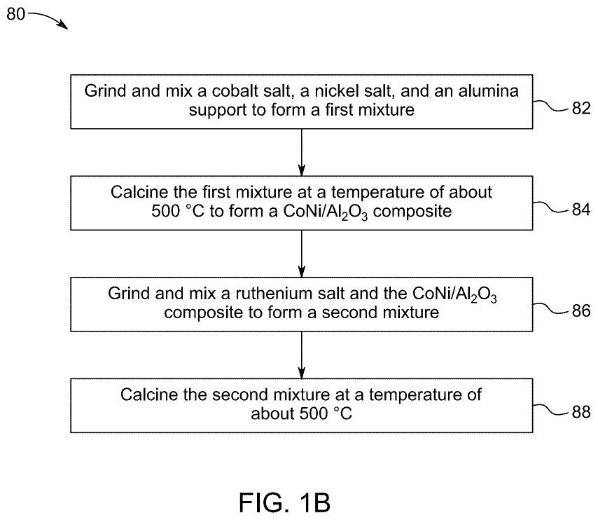

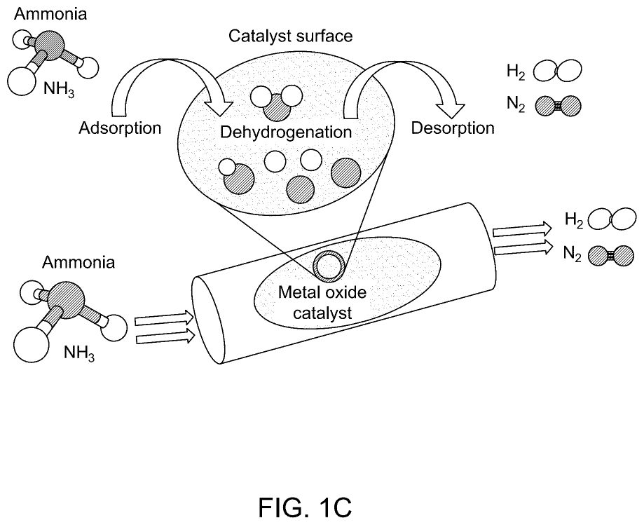

FIG. 1A illustrates a flow chart of a method 50 for ammonia (NH₃) decomposition to hydrogen (H₂) and nitrogen (N₂) using Ru—CoNi/Al₂O₃ catalyst. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes introducing a H₂-containing feed gas stream into a reactor containing ruthenium-doped alumina-supported cobalt/nickel (Ru—CoNi/Al₂O₃) catalyst including Ru—CoNi/Al₂O₃ catalyst particles. In some embodiments, the H₂ is present in the H₂-containing feed gas stream at a concentration of 90-99.99 vol. %, preferably 90.5-99.5 vol. %, preferably 91-99 vol. %, preferably 91.5-98.5 vol. %, preferably 92-98 vol. %, preferably 92.5-97.5 vol. %, preferably 93-97 vol. %, preferably 93.5-96.5 vol. %, preferably 94-96 vol. %, preferably 94.5-95.5 vol. %, based on the total volume of the H₂-containing feed gas stream. Other ranges are also possible.

In some embodiments, Ru is present in the Ru—CoNi/Al₂O₃ catalyst at a concentration of 0.01 to 5 wt. %, preferably 0.05-4.5 wt. %, preferably 0.1-4 wt. %, preferably 0.5-3.5 wt. %, preferably 1-3 wt. %, and preferably 1.5-2.5 wt. %, based on the total weight of the Ru—CoNi/Al₂O₃ catalyst. Other ranges are also possible. In a preferred embodiment, Ru is present in the Ru—CoNi/Al₂O₃ catalyst at a concentration of 0.5 wt. %. Other ranges are also possible.

In some embodiments, Al₂O₃ is present in the Ru—CoNi/Al₂O₃ catalyst at a concentration of 30-70 wt. %, preferably 31-69 wt. %, preferably 32-68 wt. %, preferably 33-67 wt. %, preferably 34-66 wt. %, preferably 35-65 wt. %, preferably 36-64 wt. %, preferably 37-63 wt. %, preferably 38-62 wt. %, preferably 39-61 wt. %, preferably 40-60 wt. %, preferably 41-59 wt. %, preferably 42-58 wt. %, preferably 43-57 wt. %, preferably 44-56 wt. %, preferably 45-55 wt. %, preferably 46-54 wt. %, preferably 47-53 wt. %, preferably 48-52 wt. %, and preferably 49-51 wt. %, based on the total weight of the Ru—CoNi/Al₂O₃ catalyst. Other ranges are also possible.

In some embodiments, a molar ratio of Co to Ni present in the Ru—CoNi/Al₂O₃ catalyst is in a range of 20:1-1:20, preferably 19:2-2:19, preferably 18:3-3:18, preferably 17:4-4:17, preferably 16:5-5:16, preferably 15:6-6:15, preferably 14:7-7:14, preferably 13:8-8:13, preferably 12:9-9:12, preferably 11:8-8:11, and preferably 10:9-9:10. Other ranges are also possible.

In some embodiments, the particles of the Ru—CoNi/Al₂O₃ catalyst may exist in various morphological shapes, such as rods, spheres, wires, crystals, rectangles, triangles, pentagons, hexagons, prisms, disks, cubes, ribbons, blocks, beads, toroids, discs, barrels, granules, whiskers, flakes, foils, powders, boxes, stars, tetrapods, belts, flowers, etc. and mixtures thereof. In a preferred embodiment, the Ru—CoNi/Al₂O₃ catalyst includes irregular-shaped particles and spherical-shaped particles. In some embodiments, the spherical-shaped particles have an average particle size in a range of 100-200 nanometers (nm), preferably 110-190 nm, preferably 120-180 nm, preferably 130-170 nm, and preferably 140-160 nm. Other ranges are also possible.

At step 54, the method 50 includes passing the H₂-containing feed gas stream through the reactor in contact with the Ru—CoNi/Al₂O₃ catalyst particles at a temperature of 500-900 degrees Celsius (° C.), preferably 510-890° C., preferably 520-880° C., preferably 530-870° C., preferably 540-860° C., preferably 550-850° C., preferably 560-840° C., preferably 570-830° C., preferably 580-820° C., preferably 590-810° C., preferably 600-800° C., preferably 610-790° C., preferably 620-780° C., preferably 630-770° C., preferably 640-760° C., preferably 650-750° C., preferably 660-740° C., preferably 670-730° C., preferably 680-720° C., preferably 690-710° C., to form a reduced Ru—CoNi/Al₂O₃ catalyst. Other ranges are also possible. In a preferred embodiment, the H₂-containing feed gas stream is passed through the reactor in contact with the Ru—CoNi/Al₂O₃ catalyst particles at a temperature of 700° C. Other ranges are also possible.

In some embodiments, the passing of the H₂-containing feed gas stream through the reactor is carried out at a weight hourly space velocity (WHSV) of about 14000-20000 L/Kg_{cat}/h, preferably 14500-19500, preferably 15000-19000, preferably 15500-18500, preferably 16000-18000, and preferably 16500-17500 L/Kg_{cat}/h at a temperature of about 500-900° C., preferably 510-890° C., preferably 520-880° C., preferably 530-870° C., preferably 540-860° C., preferably 550-850° C., preferably 560-840° C., preferably 570-830° C., preferably 580-820° C., preferably 590-810° C., preferably 600-800° C., preferably 610-790° C., preferably 620-780° C., preferably 630-770° C., preferably 640-760° C., preferably 650-750° C., preferably 660-740° C., preferably 670-730° C., preferably 680-720° C., and preferably 690-710° C. Other ranges are also possible. In a preferred embodiment, the passing of the H₂-containing feed gas stream through the reactor is carried out at a WHSV of about 18,000 L/Kg_{cat}/h at a temperature of about 700° C. Other ranges are also possible. The process described thus far results in catalyst activation by reduction.

At step 56, the method 50 includes terminating the introducing the H₂-containing feed gas stream. Once the catalyst is activated, the supply of H₂ to the reactor is stopped. The reactor temperature is subsequently set to the targeted study condition under a continuous flow of an inert gas, preferably nitrogen, preferably argon, and more preferably helium. In a preferred embodiment, the reactor temperature is subsequently set to the targeted study condition under a continuous flow of helium.

At step 58, the method 50 includes introducing and passing an NH₃-containing feed gas stream through the reactor in contact with the reduced Ru—CoNi/Al₂O₃ catalyst at a temperature of 100-1000° C., preferably 125-975° C., preferably 150-950° C., preferably 175-925° C., preferably 200-900° C., preferably 225-875° C., preferably 250-850° C., preferably 275-825° C., preferably 300-800° C., preferably 325-775° C., preferably 350-750° C., preferably 375-725° C., preferably 400-700° C., preferably 425-675° C., preferably 450-650° C., preferably 475-625° C., preferably 500-600° C., and preferably 525-575° C., thereby converting at least a portion of the NH₃ to H₂. Other ranges are also possible. In a preferred embodiment, the NH₃-containing feed gas stream is introduced and passed through the reactor in contact with the reduced Ru—CoNi/Al₂O₃ catalyst at a temperature of 900° C.

In some embodiments, the NH₃-containing feed gas stream further includes an inert gas selected from the group consisting of nitrogen, argon, and helium. In a preferred embodiment, the inert gas is helium. In some embodiments, the volume ratio of the NH₃ to the inert gas present in the NH₃-containing feed gas stream is in the range of 1:4-1:20, preferably 1:5-1:19, preferably 1:6-1:18, preferably 1:7-1:17, preferably 1:8-1:16, preferably 1:9-1:15, preferably 1:10-1:14, and preferably 1:11-1:13.

In some embodiments, the passing the NH₃-containing feed gas stream through the reactor is carried out at a WHSV of 13000-21000 L/Kg_{cat}/h, preferably 13500-20500, preferably 14000-20000, preferably 14500-19500, preferably 15000-19000, preferably 15500-18500, preferably 16000-18000, and preferably 16500-17500 L/Kg_{cat}/h at a temperature of about 400-700° C., preferably 410-690° C., preferably 420-680° C., preferably 430-670° C., preferably 440-660° C., preferably 450-650° C., preferably 460-640° C., preferably 470-630° C., preferably 480-620° C., preferably 490-610° C., preferably 500-600° C., preferably 510-590° C., preferably 520-580° C., preferably 530-570° C., and preferably 540-560° C. Other ranges are also possible. In a preferred embodiment, the passing the NH₃-containing feed gas stream through the reactor is carried out at a WHSV of 20,400 L/Kg_{cat}/h at a temperature of about 430° C. Other ranges are also possible.

In some embodiments, the reactor is at least one selected from the group consisting of a fixed-bed reactor, a trickle-bed reactor, a moving bed reactor, a rotating bed reactor, a fluidized bed reactor, and a slurry reactor. In a preferred embodiment, the reactor is a stainless-steel fixed bed tubular reactor. In an embodiment, the reactor is the fixed-bed reactor in the form of a cylindrical reactor including a top portion, a cylindrical body portion, a bottom portion, and a housing having an open top and open bottom supportably maintained with the cylindrical body portion. In some embodiments, the Ru—CoNi/Al₂O₃ catalyst is supportably retained within the housing permitting fluid flow therethrough. In some embodiments, the bottom portion is cone-shaped or pyramidal. In some embodiments, at least one propeller agitator is disposed of in the bottom portion of the reactor. In some embodiments, a plurality of recirculation tubes fluidly connects the bottom portion of the cylindrical reactor with the cylindrical body portion of the cylindrical reactor. In some embodiments, the reactor has an aspect ratio of length (L) to the inner diameter (ID) of 10:1-50:1, preferably 15:1-45:1, preferably 20:1-40:1, and preferably 25:1-35:1. In a preferred embodiment, the reactor has an aspect ratio of 22:1.

In some embodiments, the NH₃ is present in the NH₃-containing feed gas stream at a concentration of 5-20 vol. %, preferably 6-19 vol. %, preferably 7-18 vol. %, preferably 8-17 vol. %, preferably 9-16 vol. %, preferably 10-15 vol. %, preferably 11-14 vol. %, and preferably 12-13 vol. %, based on a total volume of the NH₃-containing feed gas stream. Other ranges are also possible. In a preferred embodiment, the NH₃ is present in the NH₃-containing feed gas stream at a concentration of about 10 vol. %.

At step 60, the method 50 includes regenerating the Ru—CoNi/Al₂O₃ catalyst particles to form a regenerated Ru—CoNi/Al₂O₃ catalyst and producing a residue gas stream leaving the reactor. In some embodiments, the catalytic particles may be regenerated by any method known to a person skilled in the art—for example, thermal treatment. The residue gas stream leaving the reactor includes ammonia, nitrogen, helium, and hydrogen. In some embodiments, hydrogen is released as a result of the reduction of ammonia to hydrogen by Ru—CoNi/Al₂O₃ catalyst. In some embodiments, NH₃ conversion of 60-99%, preferably 61-98%, preferably 62-97%, preferably 63-96%, preferably 64-95%, preferably 65-94%, preferably 66-93%, preferably 67-92%, preferably 68-91%, preferably 69-90%, preferably 70-89%, preferably 71-88%, preferably 72-87%, preferably 73-86%, preferably 74-85%, preferably 75-84%, and preferably 76-83% occurs based on an initial concentration of the NH₃ in the feed gas stream. Other ranges are also possible.

At step 62, the method 50 includes separating the H₂ from the residue gas stream to generate a H₂-containing product gas stream. In some embodiments, the separating the H₂ is performed by techniques such as pressure swing adsorption (PSA), membrane separation, cryogenic distillation, chemical reactions, water-gas shift reaction, and/or other techniques that are known to those skilled in the art.

In some embodiments, the separating is performed by introducing the residue gas stream into a hydrogen purification device including one or more hydrogen-selective membranes. Hydrogen purification device is configured to separate hydrogen from the residue gas stream and purifying the same. In an example, the hydrogen purification device may be a palladium membrane hydrogen purifier. The palladium membrane may include metallic tubes of palladium and silver alloy for allowing only monatomic hydrogen to pass through its crystal lattice when it is heated above 300° C. The hydrogen-selective membranes are permeable to hydrogen gas but are at least substantially impermeable to other components in the residue gas stream. In some embodiments, the plurality of hydrogen-selective membranes in the hydrogen purification device is arranged in parallel, and each membrane of the plurality of hydrogen-selective membranes is placed in a plane perpendicular to a direction of the gas mixture flow in the hydrogen purification device. The method 50 may further include passing the residue gas stream through the plurality of hydrogen-selective membranes in the hydrogen purification device thereby allowing hydrogen gas to pass through the hydrogen-selective membrane and rejecting other components in the residue gas stream to form a residue composition. The method 50 may further include collecting the hydrogen gas after passing and recycling the residue composition.

FIG. 1B illustrates a flow chart of a method 80 for preparing the Ru—CoNi/Al₂O₃ catalyst. The order in which the method 80 is described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes grinding and mixing a cobalt salt, a nickel salt, and an alumina support to form a first mixture. In some embodiments, the grinding may be carried out using any suitable means, for example, ball milling, blending, etc., using manual method 100s (e.g, mortar) or machine-assisted methods such as using a mechanical blender, or any other apparatus known to those of ordinary skill in the art. In some embodiments, the mixing may be carried out manually. In some embodiments, a weight ratio of the cobalt salt to the nickel salt present in the first mixture is in a range of 20:1-1:20, preferably 19:2-2:19, preferably 18:3-3:18, preferably 17:4-4:17, preferably 16:5-5:16, preferably 15:6-6:15, preferably 14:7-7:14, preferably 13:8-8:13, preferably 12:9-9:12, preferably 11:8-8:11, and preferably 10:9-9:10. Other ranges are also possible.

The cobalt salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate. In a preferred embodiment, the cobalt salt is cobalt nitrate [Co(NO₃)₂·6H₂O].

In some embodiments, the nickel salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

In some embodiments, the alumina support is at least one selected from the group consisting of a gamma-alumina support (γ-Al₂O₃), an alpha-alumina support (α-Al₂O₃), and a delta-alumina support (δ-Al₂O₃). In a preferred embodiment, the alumina support is γ-Al₂O₃.

At step 84, the method 80 includes calcining the first mixture at a temperature of about 400-600° C., preferably 410-590° C., preferably 420-580° C., preferably 430-570° C., preferably 440-560° C., preferably 450-550° C., preferably 460-540° C., preferably 470-530° C., preferably 480-520° C., and preferably 490-510° C., to form a CoNi/Al₂O₃ composite. Other ranges are also possible. In some embodiments, the calcination is carried out by heating it to a high temperature, under a restricted supply of ambient oxygen. This is performed to remove impurities or volatile substances and to incur thermal decomposition. In a preferred embodiment, the calcining of the second mixture is done at a temperature of 500° C. Typically, the calcination is carried out in a furnace preferably equipped with a temperature control system, which may provide a heating rate of up to 50° C./min, preferably up to 40° C./min, preferably up to 30° C./min, preferably up to 20° C./min, preferably up to 10° C./min, preferably up to 5° C./min, and more preferably up to 1° C./min. Other ranges are also possible. In a preferred embodiment, the calcination is carried out in a furnace at a heating rate of 4° C./min.

At step 86, the method 80 includes grinding and mixing a ruthenium salt and the CoNi/Al₂O₃ composite to form a second mixture. In some embodiments, the ruthenium salt includes ruthenium sulfate, ruthenium acetate, ruthenium citrate, ruthenium iodide, ruthenium chloride, ruthenium perchlorate, ruthenium nitrate, ruthenium phosphate, ruthenium triflate, ruthenium bis(trifluoromethanesulfonyl)imide, ruthenium tetrafluoroborate, ruthenium bromide, and/or its hydrate. In some embodiments, the grinding may be carried out using any suitable means, for example, ball milling, blending, etc., using manual method 100s (e.g., mortar) or machine-assisted method 100s such as using a mechanical blender, or any other apparatus known to those of ordinary skill in the art. The mixing may be carried out manually.

At step 88, the method 80 includes calcining the second mixture at a temperature of about 400-600° C., preferably 410-590° C., preferably 420-580° C., preferably 430-570° C., preferably 440-560° C., preferably 450-550° C., preferably 460-540° C., preferably 470-530° C., preferably 480-520° C., and preferably 490-510° C. Other ranges are also possible. In a preferred embodiment, the calcining of the second mixture is done at a temperature of 500° C. Other ranges are also possible. In some embodiments, the calcination is carried out in a furnace preferably equipped with a temperature control system, which may provide a heating rate of up to 50° C. per minute (° C./min), preferably up to 40° C./min, preferably up to 30° C./min, preferably up to 20° C./min, preferably up to 10° C./min, preferably up to 5° C./min, and more preferably up to 1° C./min. Other ranges are also possible. In a preferred embodiment, the calcination is carried out in a furnace at a heating rate of 3° C./min. Other ranges are also possible.

The crystalline structures of various Ni/Al₂O₃, Co/Al₂O₃, CoNi/Al₂O₃ catalysts, and the Ru-impregnated Co/Al₂O₃, Ni/Al₂O₃ and CoNi/Al₂O₃ catalysts, may be characterized by X-ray diffraction (XRD). The XRD patterns are collected in a Rigaku diffractometer equipped with a Cu-Kα radiation source (λ=0.15406 nm) for a 20 range extending between 5 and 100°, preferably 15 and 80°, further preferably 30 and 60° at an angular rate of 0.005 to 0.04° s⁻¹, preferably 0.01 to 0.03° s⁻¹, or even preferably 0.02° s⁻¹.

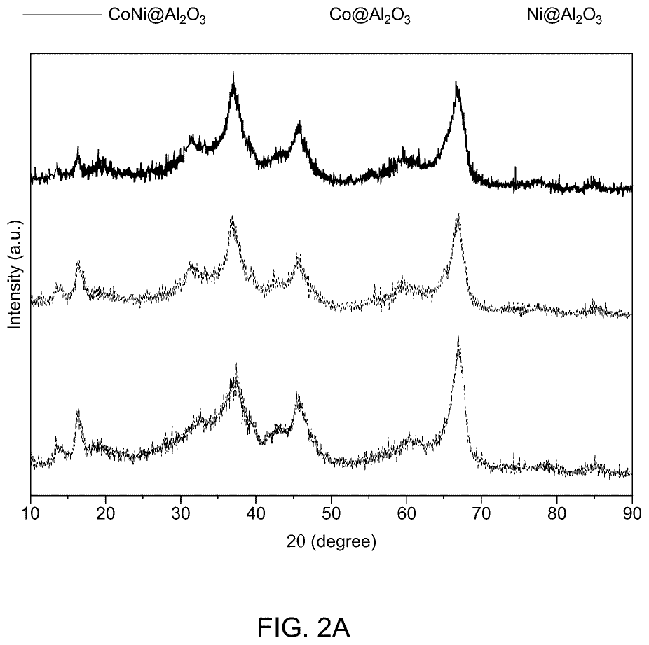

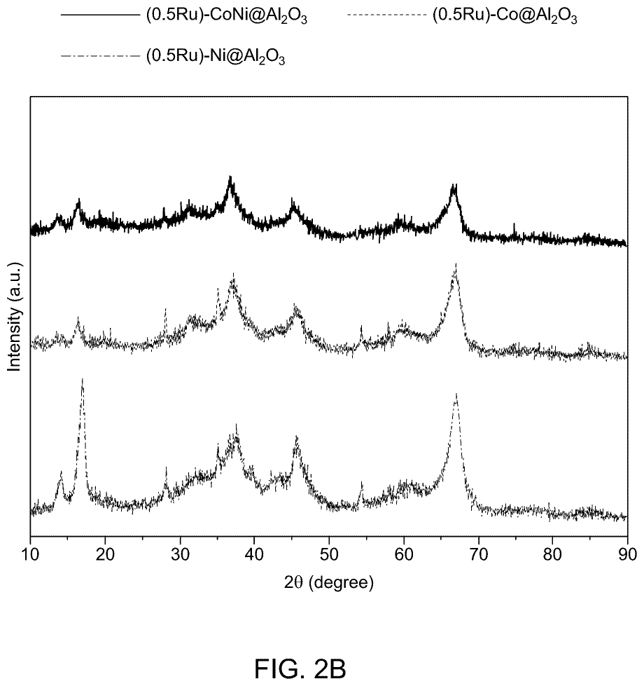

Referring to FIG. 2A, XRD profiles for Ni/Al₂O₃, Co/Al₂O₃, CoNi/Al₂O₃ catalysts. In some embodiments, the Ni/Al₂O₃ catalyst has peaks with a 2 theta (θ) value in a range of 10 to 20°, preferably 16 to 19°; 32 to 39°, preferably 35 to 37°; 40 to 50°, preferably 45 to 47°; and 60 to 70°, preferably 65 to 68°. Other ranges are also possible. In some embodiments, the Co/Al₂O₃ catalyst has peaks with a 2θ value in a range of 10 to 20°, preferably 17 to 19.5°; 30 to 40°, preferably 36 to 39°; 40 to 50°, preferably 45 to 48°; and 60 to 70°, preferably 64 to 69°. Other ranges are also possible. In some embodiments, the CONi/Al₂O₃ catalyst has peaks with a 2θ value in a range of 30 to 40°, preferably 35.5 to 39.5°; 40 to 50°, preferably 45.5 to 48.5°; and 62 to 70°, preferably 65 to 69°. Other ranges are also possible.

Referring to FIG. 2B, XRD profiles for Ru—Ni/Al₂O₃, Ru—Co/Al₂O₃, Ru—CoNi/Al₂O₃ catalysts. In some embodiments, the Ru—Ni/Al₂O₃ catalyst has peaks with a 2 theta (θ) value in a range of 10 to 15°, preferably 13 to 15°; 15 to 20°, preferably 15.5 to 17.5°; 35 to 40°, preferably 36 to 39°; 45 to 50°, preferably 46 to 48°; and 62 to 70°, preferably 65 to 68°. Other ranges are also possible. In some embodiments, the Ru—Co/Al₂O₃ catalyst has peaks with a 2θ value in a range of 13 to 20°, preferably 15 to 17.5°; 30 to 40°, preferably 36 to 39°; 40 to 50°, preferably 45 to 48°; and 60 to 70°, preferably 64 to 69°. Other ranges are also possible. In some embodiments, the Ru—CONi/Al₂O₃ catalyst has peaks with a 2θ value in a range of 15 to 20°, preferably 16 to 17.5°; 30 to 40°, preferably 36 to 38.5°; 40 to 50°, preferably 45 to 48°; and 60 to 70°, preferably 64 to 69°. Other ranges are also possible.

### EXAMPLES

The following examples demonstrate the method for the ammonia (NH₃) decomposition to hydrogen (H₂) and nitrogen (N₂) using ruthenium-doped alumina-supported cobalt/nickel (Ru—CoNi/Al₂O₃) catalyst. The examples are provided solely for illustration and are not to be construed as limitations of the present disclosure, as many variations thereof are possible without departing from the spirit and scope of the present disclosure.

### Example 1: Materials

All chemicals were purchased from Sigma-Aldrich and used as received. Dry and deoxygenated solvents were produced using standard procedures wherever needed. De-ionized water (DI) water (specific conductivity: 18.2 MΩ) was used in all experiments.

### Example 2: Synthesis of Co/Al₂O₃ Composite

The catalysts were prepared using the dry mix method without using any solvent. Firstly, an appropriate/equimolar amount of the Co(NO₃)₂·6H₂O was added to Al₂O₃ and ground with a mortar pestle for, e.g., preferably about 30 min to obtain the Co/Al₂O₃ composite. The resultant mixture was calcined at 500 degrees Celsius (° C.) in air with a temperature ramp of, e.g., preferably about 4° C./min with a temperature holding time of 5 h. A similar method was adopted to prepare the Ni/Al₂O₃ and the CoNi/Al₂O₃ composites.

### Example 3: Synthesis of Ni/Al₂O₃ Composite

The catalysts were prepared using the dry mix method without using any solvent. Firstly, an appropriate/equimolar amount of the Ni(NO₃)₂·6H₂O was added to Al₂O₃ and ground with a mortar pestle for, e.g., preferably about 30 min to obtain the Ni/Al₂O₃ composite. The resultant mixture was calcined at 500 degrees Celsius (° C.) in air with a temperature ramp of, e.g., preferably about 4° C./min with a temperature holding time of, e.g., preferably about 5 h.

### Example 4: Synthesis of CoNi/Al₂O₃ Composite

The catalysts were prepared using the dry mix method without using any solvent. Firstly, an appropriate/equimolar amount of the Ni(NO₃)₂·6H₂O, Co(NO₃)₂·6H₂O was added to Al₂O₃ and ground with a mortar pestle for, e.g., preferably about 30 min to obtain the CoNi/Al₂O₃ composite. The resultant mixture was calcined at 500 degrees Celsius (° C.) in air with a temperature ramp of, e.g., preferably about 4° C./min with a temperature holding time of, e.g., preferably about 5 h.

### Example 5: Synthesis of Ru-Impregnated Co/Al₂O₃, Ni/Al₂O₃ and CoNi/Al₂O₃ Composites

The same procedure was followed except for adding Ru precursors to the above-calcined samples. About 0.5% (wt. %) of Ru was added in the form of Ru(NO₃) to each calcined sample of Co/Al₂O₃, Ni/Al₂O₃, and CoNi/Al₂O₃ composite and ground again. Subsequently, the obtained mixture was treated with heat at, e.g., preferably about 500° C. for another 5 h with a temperature gradient of, e.g., preferably about 3° C./min.

### Example 6: Catalyst Characterization

X-ray diffraction (XRD) patterns were recorded on a Rigaku model Ultima-IV diffractometer employing Cu-Kα radiation (λ=1.5406 angstrom (Å)) at 40 kilovolts (kV) and 25 milliamperes (mA) over a 2θ range between 2° and 130°. All XRD patterns were recorded in an air atmosphere. Samples for scanning electron microscope (SEM) were prepared by applying ethanolic suspensions on single-sided alumina tape on alumina stubs. For the elemental analysis and mapping, energy-dispersive X-ray spectra (EDS) were collected on a Lyra 3 (Tescan from the Czech Republic) attachment in the SEM.

### Example 7: Methods

A stainless-steel fixed bed tubular reactor (12.7 millimeters (mm) diameter, 280 mm length) was utilized for the decomposition of ammonia (NH₃). The reactor contained, e.g., preferably about 0.1 grams (g) of catalyst and operated under atmospheric pressure, with a quartz wool plug positioned below the catalyst. A K-type thermocouple was placed at the catalyst bed center to monitor the reactor temperature. Before the reaction initiation, the catalyst underwent a reduction process by exposing it to a hydrogen gas (H₂) stream at, e.g., preferably about 700° C. and a flow rate of, e.g., preferably about 30 milliliters per minute (mL/min) for, e.g., preferably about 20 min, with a ramp rate of, e.g., preferably about 1° C. per minute (° C./min). Following the reduction step, any residual hydrogen gas was effectively purged using helium gas (He). The reactor temperature was then adjusted to the desired experimental conditions while maintaining a constant helium flow rate. FIG. 1C shows a pictorial representation of ammonia cracking.

For the reaction, a diluted mixture of ammonia (NH₃) with a 10% vol concentration, balanced with helium gas (He), was introduced into the catalyst bed. The flow rate of the mixture through the catalyst bed was set at, e.g., preferably about 34 mL/min, corresponding to an equivalent space velocity of, e.g., preferably about 20,400 L/kgcat/hr. The conversion of NH₃ was estimated once conditions attained a stable state. To quantify the NH₃ concentration, an Agilent 7890B gas chromatograph (GC) equipped with a thermal conductivity detector (TCD) was employed. The GC analysis was performed isothermally at 50° C. using an HP-PLOT U column (30 meters in length, 0.32 mm internal diameter). Helium gas served as the carrier gas for the gas composition analysis. NH₃ conversion was calculated according to the appropriate formula-

$$N {H}_{3} conversion = \frac{{NH}_{3 , i n} - {NH}_{3 , out}}{{NH}_{3 , i n}} \times 100 \qquad ( 2 )$$

### Example 8: Catalyst Characterization

The appropriate amount of nitrate salt of Co precursors was added to the γ-Al₂O₃ (e.g., preferably about 1 g) in a mortar-pestle and grinded for 30 min, and the resultant mixture was calcined at, e.g., preferably about 500° C. The ultrasmall metal oxides (Ni or Co) nanoparticles tend to block the pores of Al₂O₃, resulting in a lower surface area for the catalyst developed by the wet impregnation technique. Additionally, the homogeneous distribution of constituent elements, ease of preparation, control over the catalytic composition, and the higher prospect of scalability of this dry mixing technique make them a viable method for industrial application.

### Example 9: XRD Characterization

The XRD characterization was performed to attain the catalysts' structural information. FIG. 2A shows the XRD patterns of Ni/Al₂O₃, Co/Al₂O₃, CoNi/Al₂O₃ while FIG. 2B shows corresponding Ru-impregnated Ni/Al₂O₃, Co/Al₂O₃, CoNi/Al₂O₃ samples. The results are compared with the Al₂O₃. The diffraction patterns demonstrated a poor crystallinity of the material (See: J. Zhang, H. Xu, X. Jin, Q. Ge, W. Li, Appl. Catal. A Gen. 2005, 290, 87-96, which is incorporated herein by reference in its entirety). The intense reflections for CoO and NiO peaks are visible in the spectrum as the dopant amount was about 50 wt. % to the Al₂O₃. The broad peaks at reflection 2θ=37.5, 45.5, and 67° are attributed to the bare amorphous alumina. Meanwhile, when two metals (CoNi) were added to alumina, their individual characteristics and diffraction patterns in the XRD were observed, suggesting the incorporation into the surface of alumina separately instead of in the bimetallic form. With regards to the Ru-impregnated samples, no significant changes in diffraction patterns were observed. This may be due to the Ru was well-dispersed all over the samples, as evidenced by the elemental mapping.

### Example 10: FE-SEM Characterization

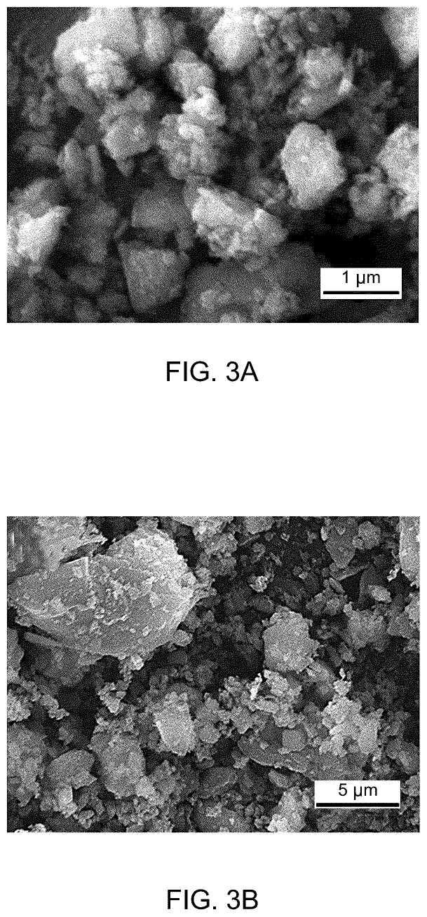

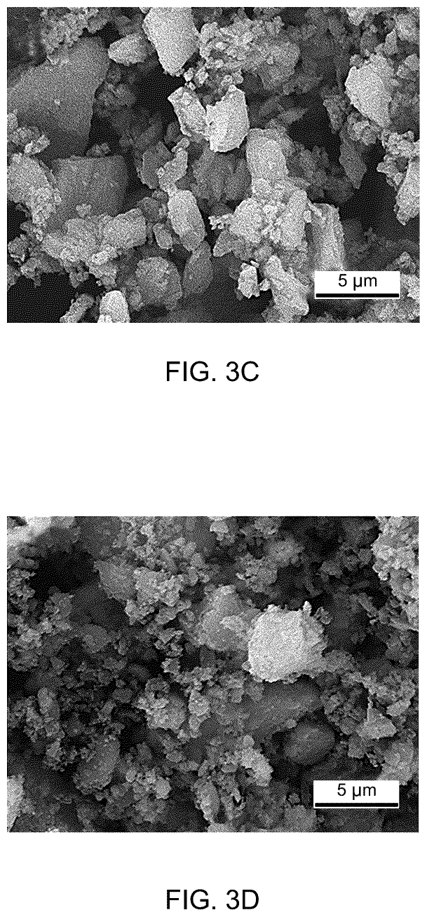

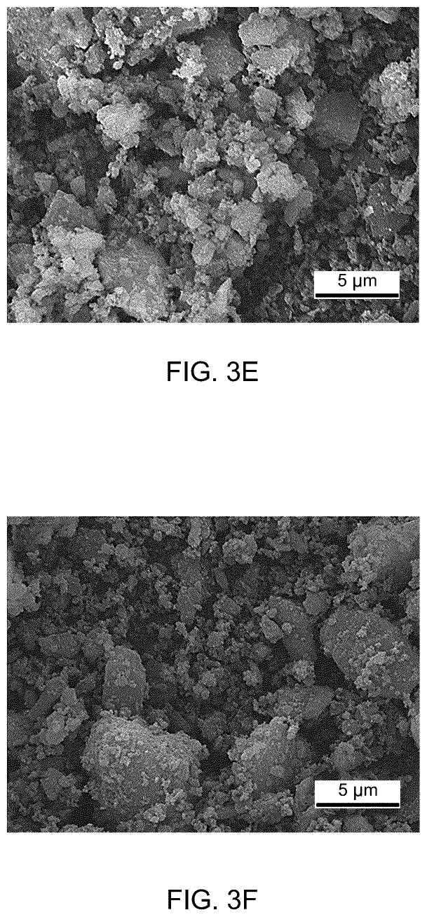

Field emission scanning electron microscopy (FE-SEM) imaging studies were performed to examine the prepared materials' surface, shape, and size. FIG. 3A-3C show SEM images of Ni/Al₂O₃, Co/Al₂O₃, and CoNi/Al₂O₃ while FIG. 3D-3F shows SEM images of Ru-impregnated Ni/Al₂O₃, Co/Al₂O₃, and CoNi/Al₂O₃ samples, showing highly agglomerated spherical particles distributed as a chunk all over the frame, and this trend continues from Ni/Al₂O₃ to CoNi/Al₂O₃. However, after the impregnation of the Ru into the system, the morphology of the catalysts improved drastically towards more dispersion of the constituents. The spherically shaped particles with sizes range from 100-200 nm.

### Example 11: EDS Characterization

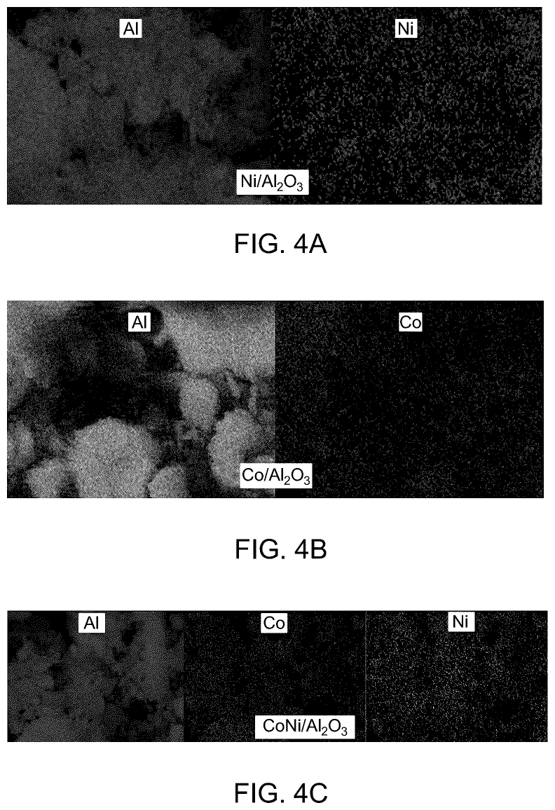

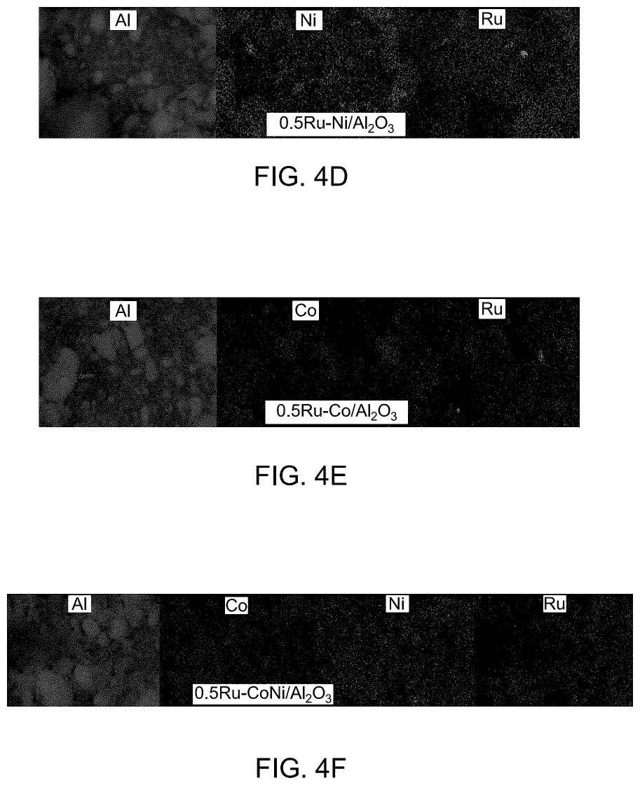

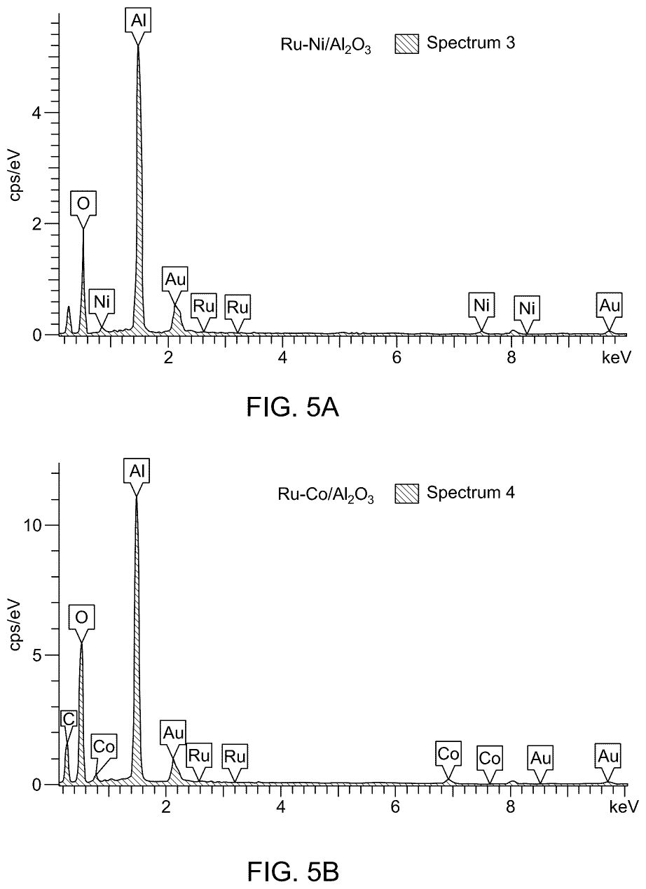

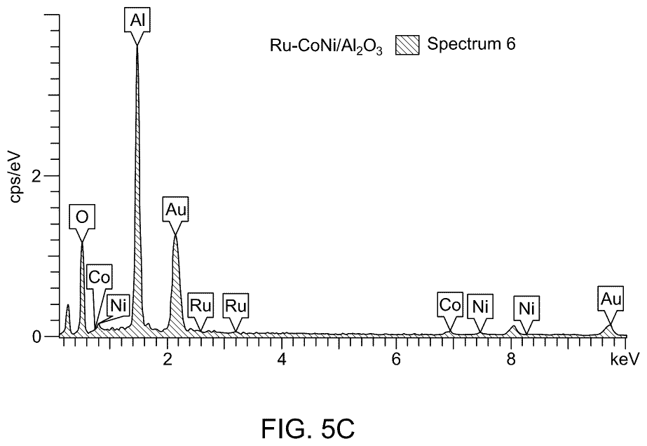

The Energy dispersive X-ray spectroscopic (EDS) studies were performed to examine the dispersion of the constituent elements in the composition. FIG. 4A-4C show EDS-elemental mapping images of Ni/Al₂O₃, Co/Al₂O₃, and CoNi/Al₂O₃. The uniform and homogeneous distribution of the Ni on the alumina was observed, and this trend was observed in all the samples. FIG. 4D-4F show EDS-elemental mapping images of Ru-impregnated Ni/Al₂O₃, Co/Al₂O₃, CoNi/Al₂O₃ samples. The Ru distribution all over the surface of the Al₂O₃ was also supported by XRD diffraction patterns. The constituent elements, such as Ni, Co, Al, and Ru, were identified by their electron emission energies. FIG. 5A-5C show EDS spectra of Ru-impregnated Ni/Al₂O₃, Co/Al₂O₃, and CoNi/Al₂O₃ samples, respectively.

### Example 12: Catalyst Test

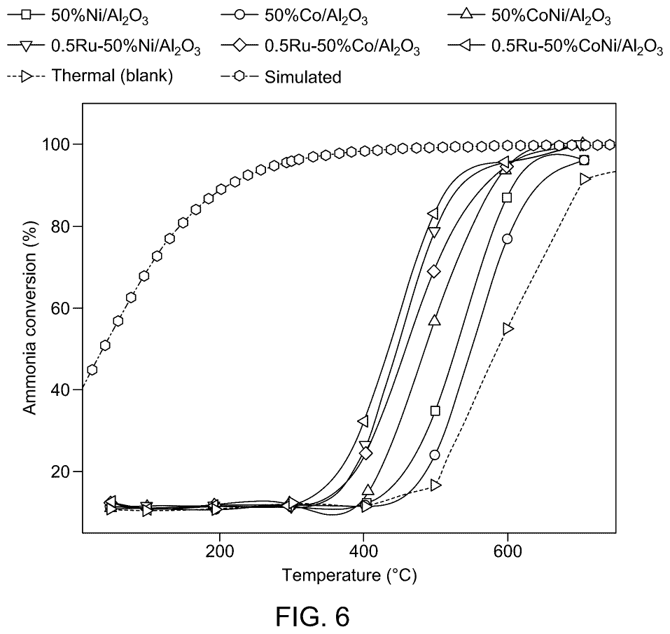

The catalytic performances of Ni/Al₂O₃, Co/Al₂O₃, CoNi/Al₂O₃, and its corresponding 0.5 wt. % Ru-impregnated catalysts in NH₃ decomposition reactions are presented in FIG. 6. The pre-treated catalysts (e.g., preferably about 100 mg) with H₂ at, e.g., preferably about 700° C. and 10% NH₃ were used with the gas hourly space velocity (GHSV) of, e.g., preferably about 24000 mLg_{cat}⁻¹ h⁻¹. FIG. 6 shows that as the temperature increased, the NH₃ conversion was also increased even without the catalyst (dotted line, blank), which agrees with the nature of the endothermic reaction. However, when the Co/Al₂O₃ sample is placed, the activity toward ammonia cracking becomes evident in lower temperatures. For instance, 50% of the introduced ammonia is cracked at, e.g., preferably about 550° C., and about 96% of the ammonia is converted to H₂ at, e.g., preferably about 708° C. An improvement is observed with the replacement of the same amount of Co with Ni, and the 98% conversion of ammonia to H₂ is achieved at, e.g., preferably about 654° C.

Furthermore, combining both active metals and keeping the metal-to-alumina ratio (Co+Ni=50 wt. % to Al₂O₃) unchanged, the catalyst started to crack the ammonia at, e.g., preferably about 380° C. and reached up to >99% at, e.g., preferably about 625° C. Notably, further enhancement is recorded with the addition of a trace amount of Ru into the Ni/Al₂O₃, Co/Al₂O₃, and CoNi/Al₂O₃. Here, Ru—Ni/Al₂O₃ catalyst demonstrated much better activity than its monometallic counterpart Ru—Co/Al₂O₃. At the lower temperature, both catalysts follow the same trend up to 400° C., and then a reasonably faster rate of decomposition of ammonia is noted with the Ni/Al₂O₃ catalyst. Additionally, it follows a similar path as that of the bimetallic system with Ru (Ru—CoNi/Al₂O₃).

The use of cobalt (Co) and nickel (Ni) is done as earth-abundant and economically viable elements for the synthesis of catalyst. The cost-effective Co and Ni metal on alumina-supported catalysts were prepared through a dry mixing method. The Ru—CoNi/Al₂O₃ catalyst demonstrates enhanced ammonia decomposition activity. The results show that Ni cracks ammonia at a relatively lower temperature than Co, and the combination of both metals surpassed the ammonia decomposition reaction even lower temperature than each Co and Ni. The reactivity trend in 0.5% Ru-dopped catalysts from cracking 50% ammonia can be established as 0.5% Ru—CoNi/Al₂O₃ (430° C.)>0.5% Ru—Ni/Al₂O₃ (450° C.)>0.5% Ru—Co/Al₂O₃ (465° C.). On the other hand, metal on alumina decomposes 50% ammonia at 550° C. for Co/Al₂O₃, 530° C. for Ni/Al₂O₃, and 485° C. for CoNi/Al₂O₃.

Numerous modifications and variations of the present disclosure are possible in light of the above teachings. It is therefore to be understood that within the scope of the appended claims, the invention may be practiced otherwise than as specifically described herein.

1: A method for ammonia (NH₃) decomposition to hydrogen (H₂) and nitrogen (N₂), including:
introducing a H₂-containing feed gas stream into a reactor containing a ruthenium-doped alumina-supported cobalt/nickel (Ru—CoNi/Al₂O₃) catalyst including Ru—CoNi/Al₂O₃ catalyst particles;
wherein Ru is present in the Ru—CoNi/Al₂O₃ catalyst at a concentration of 0.01 to 5 wt. % based on a total weight of the Ru—CoNi/Al₂O₃ catalyst;
passing the H₂-containing feed gas stream through the reactor to contact the H₂-containing feed gas stream with the Ru—CoNi/Al₂O₃ catalyst particles at a temperature of 500 to 900° C. to form a reduced Ru—CoNi/Al₂O₃ catalyst;
terminating the introducing the H₂-containing feed gas stream;
introducing and passing an NH₃-containing feed gas stream through the reactor to contact the NH₃-containing feed gas stream with the reduced Ru—CoNi/Al₂O₃ catalyst at a temperature of 100 to 1000° C. thereby converting at least a portion of the NH₃ to H₂ and regenerating the Ru—CoNi/Al₂O₃ catalyst particles to form a regenerated Ru—CoNi/Al₂O₃ catalyst, and producing a residue gas stream leaving the reactor; and
separating the H₂ from the residue gas stream to generate a H₂-containing product gas stream.

2: The method of claim 1, wherein the Ru—CoNi/Al₂O₃ catalyst includes irregular shaped particles and spherical shaped particles.

3: The method of claim 2, wherein the spherical shaped particles have an average particle size in a range of 100 to 200 nanometers (nm).

4: The method of claim 1, wherein Al₂O₃ is present in the Ru—CoNi/Al₂O₃ catalyst at a concentration of 30 to 70 wt. % based on the total weight of the Ru—CoNi/Al₂O₃ catalyst.

5: The method of claim 1, wherein a molar ratio of Co to Ni present in the Ru—CoNi/Al₂O₃ catalyst is in a range of 20:1 to 1:20.

6: The method of claim 1, wherein the H₂ is present in the H₂-containing feed gas stream at a concentration of 90 to 99.99 vol. % based on a total volume of the H₂-containing feed gas stream.

7: The method of claim 1, wherein the NH₃ is present in the NH₃-containing feed gas stream at a concentration of 5 to 20 vol. % based on a total volume of the NH₃-containing feed gas stream.

8: The method of claim 1, wherein the NH₃-containing feed gas stream further includes an inert gas selected from the group consisting of nitrogen, argon, and helium, wherein the residue gas stream leaving the reactor includes ammonia, nitrogen, helium, and hydrogen, and wherein a volume ratio of the NH₃ to the inert gas present in the NH₃-containing feed gas stream is in a range of 1:4 to 1:20.

9: The method of claim 1, wherein the reactor is at least one selected from the group consisting of a fixed-bed reactor, a trickle-bed reactor, a moving bed reactor, a rotating bed reactor, a fluidized bed reactor, and a slurry reactor.

10: The method of claim 1, wherein the reactor is a fixed-bed reactor in the form of a cylindrical reactor including:
a top portion;
a cylindrical body portion;
a bottom portion;
a housing having an open top and open bottom supportably maintained with the cylindrical body portion;
wherein the Ru—CoNi/Al₂O₃ catalyst is supportably retained within the housing permitting fluid flow therethrough;
at least one propeller agitator disposed in the bottom portion of the reactor;
wherein the bottom portion is cone shaped or pyramidal; and
wherein a plurality of recirculation tubes fluidly connects the bottom portion of the cylindrical reactor with the cylindrical body portion of the cylindrical reactor.

11: The method of claim 10, wherein the reactor has an aspect ratio of length (L) to inner diameter (ID) of 10:1 to 50:1.

12: The method of claim 1, wherein the passing the H₂-containing feed gas stream through the reactor at a weight hourly space velocity of about 18,000 L/Kg_{cat}/hr at a temperature of about 700° C.

13: The method of claim 1, wherein the passing the NH₃-containing feed gas stream through the reactor at a weight hourly space velocity of about 20,400 L/Kg_{cat}/hr at a temperature of from 400 to 700° C.

14: The method of claim 13, wherein the method has an ammonia conversion of 60 to 99% based on an initial concentration of the NH₃ in the feed gas stream.

15: The method of claim 1, further including:
preparing the Ru—CoNi/Al₂O₃ catalyst by:
grinding and mixing a cobalt salt, a nickel salt, and an alumina support to form a first mixture; and
calcining the first mixture at a temperature of about 500° C. to form a CoNi/Al₂O₃ composite;
grinding and mixing a ruthenium salt and the CoNi/Al₂O₃ composite to form a second mixture; and
calcining the second mixture at a temperature of about 500° C.

16: The method of claim 15, wherein a weight ratio of the cobalt salt to the nickel salt present in the first mixture is in a range of 20:1 to 1:20.

17: The method of claim 15, wherein the alumina support is at least one selected from the group consisting of a gamma-alumina support (γ-Al₂O₃), an alpha-alumina support (α-Al₂O₃), and a delta-alumina support (δ-Al₂O₃).

18: The method of claim 15, wherein the cobalt salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate.

19: The method of claim 15, wherein the nickel salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

20: The method of claim 15, wherein the ruthenium salt includes ruthenium sulfate, ruthenium acetate, ruthenium citrate, ruthenium iodide, ruthenium chloride, ruthenium perchlorate, ruthenium nitrate, ruthenium phosphate, ruthenium triflate, ruthenium bis(trifluoromethanesulfonyl)imide, ruthenium tetrafluoroborate, ruthenium bromide, and/or its hydrate.
